(19) United States
(12) Patent Application Publication
(10) Pub. No.: US 2015/0143545 A1
(43) Pub. Date: May 21, 2015

(54) Function for the Challenge Derivation for Protecting Components in a Challenge-Response Authentication Protocol

(71) Applicants: Rainer Falk, Poing (DE); Steffen Fries, Baldham (DE)

(72) Inventors: Rainer Falk, Poing (DE); Steffen Fries, Baldham (DE)

(21) Appl. No.: 14/403,512

(22) PCT Filed: Mar. 21, 2013
(86) PCT No.: PCT/EP2013/055923

§ 371 Date: Nov. 24, 2014

(30) Foreign Application Priority Data
May 25, 2012 (DE) 10 2012 208 834.2

(51) Int. Cl. G06F 21/44

(52) U.S. Cl. CPC G06F 21/44
USPC 726/30

(57) ABSTRACT

The invention relates to a device for authenticating a product with respect to at least one authenticator. Said device comprises a capturing unit, a test unit and a transmitting unit. Said capturing unit is designed to capture a challenge emitted by the authenticator. Said test unit is designed to test an authorization from the authenticator for capturing a response to the emitted challenge. Said transmitter unit is designed to transmit a predetermined response to the authenticator in accordance with the tested authorization and the captured challenge. As a result, increased security during the authentication is ensured. The invention also relates to a system comprising said type of device and an authenticator, and to a method and a computer program product for authenticating a product.

This application is the National Stage of International Application No. PCT/EP2013/055923, filed Mar. 21, 2013, which claims the benefit of DE 10 2012 208 834.2, filed May 25, 2012. The entire contents of these documents are hereby incorporated herein by reference.

### BACKGROUND

The present embodiments relate to authenticating a product with respect to an authenticator.

A product (e.g., a device or an object) may be authenticated using a challenge-response method. In this case, a query message or a challenge message, which is formed based on a random number, for example, is transmitted by the authenticator to the product to be authenticated.

The product to be authenticated then calculates a response value or a response message (e.g., based on a secret cryptographic key). This response message is sent back to the authenticator, which checks the response message for correctness. Since only an original product or an original device may calculate a correct response message, an original product or an original device may therefore be reliably distinguished from a counterfeit.

A challenge-response authentication may also be carried out using a physical object property (e.g., a physical unclonable function (PUF)).

Physical unclonable functions (PUF) are known for the purpose of reliably identifying physical objects or products. In this case, a physical property of a product (e.g., a semiconductor module) may also be used as an individual “fingerprint”. The authentication of the product is then based on the fact an associated response message (e.g., response value), which is determined by a PUF function defined by a physical property, is returned to the authenticator based on a query message (e.g., challenge value). In contrast to a conventional cryptographic challenge-response authentication, it is not possible in this case to select an arbitrary value from a wide range of values in a (pseudo) random manner for the query message (e.g., challenge). In this case, only the query messages for which an associated reference value is known in the authenticator may be checked.

It is also known practice to carry out a PUF-based authentication. In this case, challenge-response pairs of another, trusted entity are used for the first time to acquire reference data for further challenge-response pairs that may be used for subsequent authentications. This is described in the document US 2009/0083833 A1, for example.

The document DE 10 2009 030 019 B3 shows a system and a method for reliably authenticating a device. In this case, a query message is tied to a checking apparatus using an item of checker context information. It is therefore more difficult for an attacker to feign an identity of a device. This application is used in authentication scenarios (e.g., in telecommunications in which sensitive messages are interchanged).

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a product is authenticated more reliably with respect to at least one authenticator.

An apparatus for authenticating a product with respect to at least one authenticator is provided. The apparatus includes a receiving unit, a checking unit and a transmitting unit. The receiving unit is set up to receive a query message transmitted by the authenticator. The checking unit is set up to check an authorization of the authenticator to receive a response message to the transmitted query message. The transmitting unit is set up to transmit a predetermined response message to the authenticator based on the checked authorization and the received query message.

The apparatus provides increased security during authentication since only the query messages (e.g., challenge messages, challenges) that have been transmitted by an authenticator also with corresponding authorization are actually answered by the transmitting unit with a corresponding response message. In other words, if an authorization check reveals that the use of the received query message or challenge is permissible, the associated response message or response is transmitted from the transmitting unit to the authenticator.

It is possible, for example, to restrict which authenticator may use which challenge values or which ranges of challenge values. Uncontrolled multiple use of challenge values that may result in reduced security may be prevented. Particular challenge values may be used to reconstruct a cryptographic key, whereas other particular challenge values of the same PUF are used for an authentication. It is therefore possible to prevent an authenticator receiving response messages that made it possible to reconstruct a cryptographic key.

A plurality of keys may be reconstructable. In this case, a range of challenge values is assigned to each key. For example, a plurality of applications may each reconstruct their own key from the response messages intended for respectively allowed challenge values. A physical PUF may therefore be used by different applications.

A product to be authenticated may be an object (e.g., a semiconductor module), a sensor node, a control device, a particular code in an FPGA, a battery or a toner or a toner cartridge or else an RFID tag on a toner or a toner cartridge.

An authenticator may be any apparatus that is suitable for communication and may participate in a challenge-response method. The authenticator may be an authentication server, for example. The query message may also be referred to as a challenge, challenge value or challenge message. Accordingly, the response message may also be referred to as a response or response value. The authorization may also be referred to as an authentication token or authorization token or may be coded. Examples of this are SAML assertion, attribute certificate and XML assertion. The authorization token therefore codes the authorization. The authorization token is protected with a cryptographic checksum (e.g., in order to be protected itself from manipulation) or is provided using a protected communication connection. Examples of cryptographic checksums include message authentication code and digital signature. Examples of such a protected communication connection include IPsec, SSL and TLS.

Possible criteria for checking the authorization may be an item of identity information relating to the authenticator (e.g., a Network Access Identifier (NAI), IP address, MAC address, public key, public key hash, process ID, hash of the program code or file name of the program code). An item of context information such as current location, current time or current operating state may be used to check the authorization. The number of times a challenge value has already been used may be used to check the authorization. The time at which this challenge value was last used or the period of time since the last use of this challenge value may also be used to check the authorization.

The number of challenge-response pairs of an authenticator that are still free and have not been used or else the number of checks by this authenticator may also be included in the authorization check.

The present authorization check of the challenges is advantageous, for example, in the case of PUFs since it is not possible to use any desired challenges but rather only challenges for which reference data are available for checking.

In one embodiment, the apparatus is integrated with the receiving unit, the checking unit and the transmitting unit in the product.

The product (e.g., a battery) has the apparatus or authentication apparatus.

In another embodiment, the receiving unit and the transmitting unit are integrated in the product. The checking unit is connected upstream of the product such that query messages addressed to the receiving unit of the product may be transmitted only via the checking unit of the apparatus.

In this embodiment, a conventional product may be authenticated according to one or more of the present embodiments without change since the checking unit is not part of the product but rather is only connected upstream of this product. Therefore, the checking unit is in the form of an upstream device or an upstream challenge authorization checking apparatus.

In another embodiment, the receiving unit is set up to receive an item of identification information with the query message from the authenticator. The checking unit is set up to check the authorization of the authenticator to receive the response message to the transmitted query message based on the received identity information.

The identification information relating to the authenticator is a simple implementation for checking the authorization for receiving a response message by the authenticator.

In another embodiment, the apparatus has a storage device for storing at least one item of authorization information for the authorization of at least one authenticator. In this case, the checking unit is set up to check the authorization of the authenticator based on the received query message and the at least one stored item of authorization information.

The product may therefore check the authorization relating to whether the query message is permissible using locally stored authorization information. A set of permissible challenge values or else a permissible range of challenge values may therefore be assigned to a respective authenticator.

In another embodiment, the receiving unit is set up to receive an item of authorization information with the query message from the authenticator. In this case, the checking unit is set up to check the authorization of the authenticator to receive the response message to the transmitted query message based on the received authorization information.

The authorization information may be in the form of a protected authorization token, for example. The authorization token or authentication token is transmitted from the authenticator to the apparatus (e.g., with the query message). The authorization token confirms the authorized use of a challenge value to the apparatus.

In another embodiment, the apparatus has a storage device for storing a number of items of authorization information for the authorization of a number of authenticators. A request message to be received is assigned to the respective authorization information. The apparatus has an updating unit for updating the respective authorization information if the receiving unit receives the query message assigned to the respective authorization information.

Therefore, when using a challenge for verification (e.g., for the second or subsequent use), the authorization may be revoked in order to prevent further use of this challenge.

In another embodiment, the updating unit is set up to update the respective authorization information such that the associated authorization is revoked if the receiving unit receives the query message assigned to the respective authorization information.

The security level information may be used to indicate the security level of the current challenge-response authentication to the authenticator. The security level information may be in the form of a flag or trust value in the response message, for example.

In another embodiment, the updating unit provides an item of security level information for the received query message based on the updated authorization information. In this case, the transmitting unit is set up to transmit the provided security level information with the predetermined response message to the authenticator.

For example, the system may have a plurality of PUF authentication servers since, in such a case, it is possible to control which PUF authentication server may use which challenge values according to one or more of the present embodiments. It is also possible to restrict when a particular authentication server may authenticate a product or object (e.g., only as long as a best-before date has not expired). An object may also be authenticated only as long as the object is at a particular location or in a particular region. This information may be concomitantly included in the authorization check from the context information.

In another embodiment, the checking unit is set up to check the format and/or the content of the received query message before checking the authorization of the authenticator.

The respective unit, receiving unit, checking unit and transmitting unit may be implemented using hardware and/or else software. In the case of a hardware implementation, the respective unit may be in the form of an apparatus or part of an apparatus (e.g., a computer or microprocessor). In the case of a software implementation, the respective unit may be in the form of a computer program product, a function, a routine, part of a program code or an executable object.

A system having at least one authenticator and an apparatus for authenticating a product with respect to the at least one authenticator, as described above, is also provided. The authenticator is set up to transmit a query message to the apparatus and to receive and check a response message that is received from the apparatus in response to the transmitted query message.

In one development, the authenticator and the apparatus are set up such that the authenticator is authenticated with respect to the apparatus.

In another development, the system has at least one first authenticator and one second authenticator. In this case, the first authenticator is set up to generate an authorization to receive a response message from the apparatus by transmitting a query message to the apparatus and by receiving a corresponding response message from the apparatus, and to forward the generated authorization with an integrity-protected forwarding message to the second authenticator.

A method for authenticating a product with respect to at least one authenticator is also provided. In a first act, a query message transmitted by the authenticator is received. In a second act, an authorization of the authenticator to receive a response message to the transmitted query message is checked. In a third act, a predetermined response message is transmitted to the authenticator based on the checked authorization and the received query message.

A computer program product (e.g., including a non-transitory computer-readable storage medium) that causes the method explained above to be carried out on a program-controlled device is also provided.

A computer program product such as a computer program may be provided or delivered, for example, in the form of a storage medium such as a memory card, a USB stick, a CD-ROM, a DVD or else in the form of a downloadable file from a server in a network. This may be effected, for example, in a wireless communication network, by transmitting a corresponding file containing the computer program product or the computer program.

In addition, a data storage medium (e.g., a non-transitory computer-readable storage medium) having a stored computer program with instructions that cause the method explained above to be carried out on a program-controlled device is also provided.

### BRIEF DESCRIPTION OF THE DRAWINGS

FIG. 1 shows a block diagram of a first exemplary embodiment of an apparatus for authenticating a product;

FIG. 2 shows a block diagram of a second exemplary embodiment of an apparatus for authenticating a product;

FIG. 3 shows a block diagram of a third exemplary embodiment of an apparatus for authenticating a product;

FIG. 4 shows a block diagram of an exemplary embodiment of a system for authenticating a product with two authentication servers; and

FIG. 5 shows a flowchart of an exemplary embodiment of a method for authenticating a product.

### DETAILED DESCRIPTION OF THE DRAWINGS

In the figures, same or functionally same elements have been provided with the same reference symbols unless indicated otherwise.

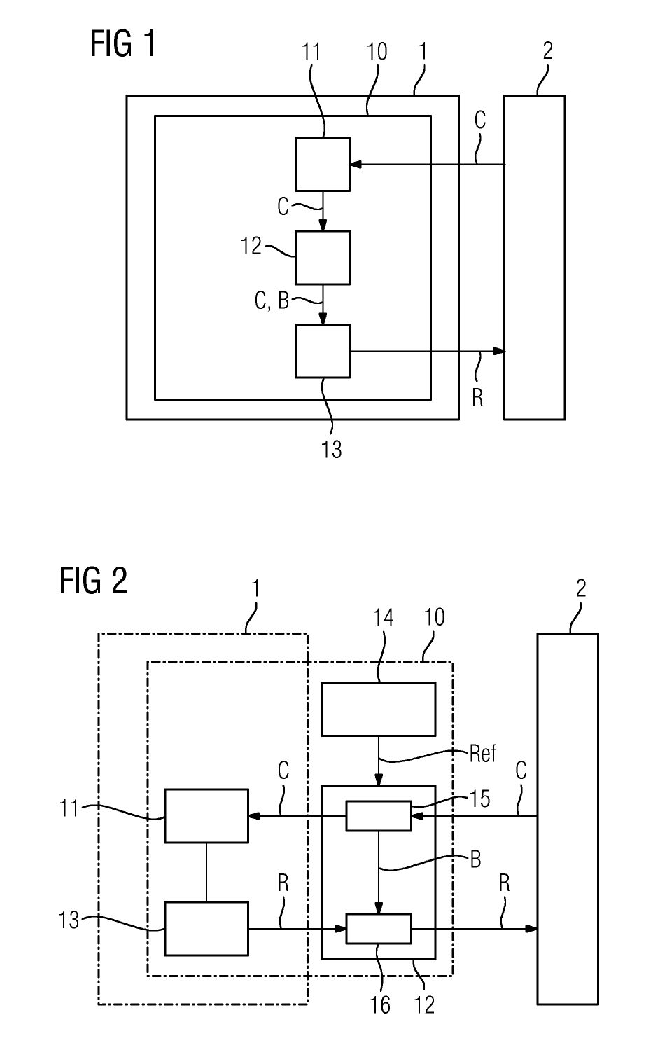

FIG. 1 shows a block diagram of a first exemplary embodiment of an apparatus 10 for authenticating a product 1 with respect to an authenticator 2. The apparatus 10 and the authenticator 2 are coupled via a communication connection.

In the exemplary embodiment in FIG. 1, the apparatus 10 is part of the product 1 to be authenticated.

The apparatus 10 has a receiving unit 11, a checking unit 12 and a transmitting unit 13.

The receiving unit 11 is set up to receive a query message C transmitted by the authenticator 2. The checking unit 12 checks the authorization B of the authenticator 2 to receive a response message R to the transmitted query message C.

The transmitting unit 13 is set up to transmit a predetermined response message R to the authenticator 2 based on the checked authorization B and the received query message C. In other words, the checked authorization B indicates whether or not a response message R is intended to be transmitted to the authenticator 2. Such a response message R is transmitted to the authenticator 2 only in the case of a positive authorization B of the authenticator 2. In the case of a positive authorization of the authenticator 2, the type of response message R is determined (e.g., based on the checked authorization B and/or the received query message C).

The authenticator 2 may use the query message C to transmit an item of identification information relating to a corresponding identification with respect to the apparatus 10 to the latter.

The identification information may be used to check the authorization of the authenticator 2.

Alternatively or additionally, the authenticator 2 may transmit an item of authorization information with the query message C to the receiving unit 11 of the apparatus 10. The authorization information may directly indicate that the authenticator 2 is authorized to receive response messages R from the apparatus 10. In other words, the checking unit 12 then checks the authorization B of the authenticator 2 to receive the response message R to the transmitted query message C based on the received authorization information.

Additionally, the checking unit 12 may be set up to check the format of the received query message C before checking the authorization B of the authenticator 2. For example, the authorization B of the authenticator 2 is checked by the checking unit 12 only when the format of the received query message C corresponds to a predetermined format.

FIG. 2 illustrates a block diagram of a second exemplary embodiment of an apparatus 10 for authenticating a product 1 with respect to an authenticator 2.

The second exemplary embodiment in FIG. 2 differs from the first exemplary embodiment in FIG. 1 (e.g., to the effect that the receiving unit 11 and the transmitting unit 13 of the apparatus 10 are integrated in the product 1 to be authenticated, but the checking unit 12 is not part of the product 1, but rather is connected upstream of the latter). The checking unit 12 is connected upstream of the product 1 such that query messages C addressed to the receiving unit 11 of the product 1 may be transmitted solely via the checking unit 12 of the apparatus 10. For this purpose, the checking unit 12 may have a checking device 15 that checks the authorization B of the authenticator 2. In the case of a positive authorization B, the checking device 15 transmits an authorization signal B to a switching device 16 that then effects the communication connection between the transmitting unit 13 of the apparatus 10 and the authenticator 2. If the checking device 15 determines an impermissible authorization, the checking device 15 drives the switching device 16 such that the communication connection between the transmitting unit 13 and the authenticator 2 is interrupted.

A storage device 14 for storing at least one item of authorization information Ref for the authorization of the authenticator 2 is provided in the second exemplary embodiment in FIG. 2. The checking unit 12 may check the authorization B of the authenticator 2 based on the received query message C and the stored authorization information Ref. For example, the stored authorization information Ref may also be referred to as reference values or reference data.

The storage device 14 may also be set up to store a plurality of items of authorization information Ref for the authorization of a plurality of authenticators 2. A request message C to be received is assigned to the respective item of authorization information Ref.

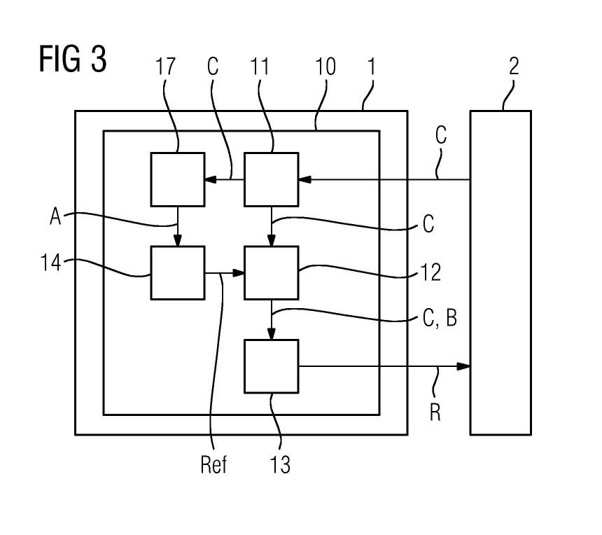

FIG. 3 shows a block diagram of a third exemplary embodiment of an apparatus 10 for authenticating a product 1. The third exemplary embodiment in FIG. 3 is based on the first exemplary embodiment in FIG. 1. The apparatus 10 in FIG. 3 also includes a storage device 14 and an updating unit 17. The storage device 14 of the apparatus 10 is set up to store a number of items of authorization information Ref for the authorization of a number of authenticators 2. A request message C to be received is assigned to the respective item of authorization information Ref.

The storage device 14 is coupled, for example, between the updating unit 17 and the checking unit 12. The updating unit 17 is set up to update the respective item of authorization information Ref in the storage device 14 using an updating signal A if the receiving unit 11 receives the query message C assigned to the respective item of authorization information Ref from an authenticator 2. For example, the updating unit 17 may also be set up to update the respective item of authorization information Ref such that the associated authorization B is revoked if the receiving unit 11 receives the query message C assigned to the respective item of authorization information Ref.

The updating unit 17 may be set up to generate an item of security level information for the received query message C based on the updated authorization information Ref. The transmitting unit 13 may be set up to transmit the generated security level information with the predetermined response message R to the authenticator 2.

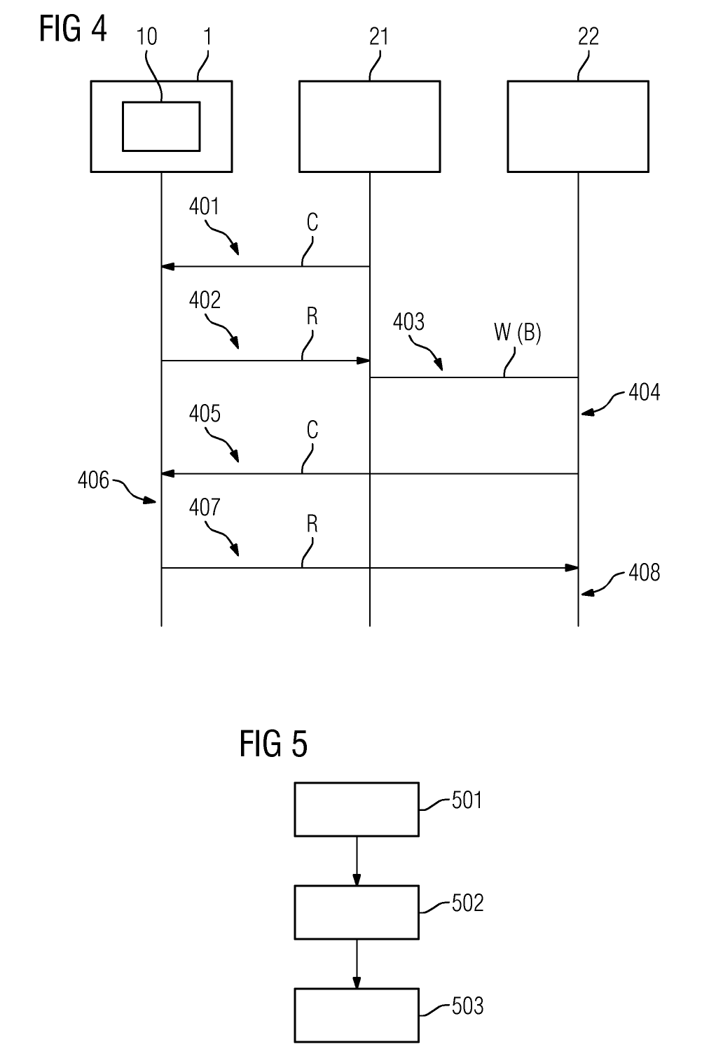

FIG. 4 shows a block diagram of an exemplary embodiment of a system for authenticating a product 1 with two authentication servers 21, 22. In this case, a first authentication server 21 carries out an enrollment phase (acts 401-403) in which challenge-response pairs are generated from challenges and responses. In this case, a challenge-response pair indicates an authorization of the querying authentication server. The first authentication server 21 may forward or delegate these authorizations to the further, second authorization server 22. In an application phase (acts 404-408) following the enrollment phase (acts 401-403), the second authentication server 22 may use the delegated authorization of the authentication server 21. This is explained in detail below with reference to FIG. 4.

In act 401, the first authentication server 21 transmits a challenge C to the apparatus 10. The apparatus 10 responds with a response R in act 402. In act 403, the first authentication server 21 transmits a forwarding message W with the authorization B to receive responses from the apparatus 10 to the second authentication server 22. In act 404, the second authentication server 22 generates a challenge C with the transmitted authorization B. In act 405, the second authentication server 22 transmits the generated challenge C to the apparatus 10. In act 406, the apparatus 10 checks the received authorization that has been delegated to the second authentication server 22 by the first authentication server 21. Since this authorization is permissible because the authorization was generated in the enrollment phase, the apparatus 10 may transmit a response R to the second authentication server 22 in act 406. In act 407, the second authentication server 22 verifies the received response R.

FIG. 5 illustrates a flowchart of an exemplary embodiment of a method for authenticating a product with respect to an authenticator.

In act 501, a query message transmitted by the authenticator is received by the product.

In act 502, an authorization of the authenticator to receive a response message to the transmitted query message is checked by the product.

In act 503, a predetermined response message is transmitted from the product to the authenticator based on the checked authorization and the received query message.

Although the invention has been described and illustrated in detail by exemplary embodiments, the invention is not restricted by the disclosed examples. Other variations may be derived therefrom by a person skilled in the art without departing from the scope of protection of the invention.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. An apparatus for authenticating a product with respect to at least one authenticator, the apparatus comprising:
a receiving unit configured to receive a query message transmitted by the at least one authenticator;
a checking unit configured to check an authorization of the at least one authenticator to receive a response message to the received query message; and
a transmitting unit configured to transmit a predetermined response message to the at least one authenticator based on checked authorization and the received query message.

2. The apparatus of claim 1, wherein the apparatus his integrated with the receiving unit, the checking unit and the transmitting unit in the product.

3. The apparatus of claim 1, wherein the receiving unit and the transmitting unit are integrated in the product, and the checking unit is connected upstream of the product such that query messages addressed to the receiving unit of the product are transmittable only via the checking unit of the apparatus.

4. The apparatus of claim 1, wherein the receiving unit is configured to receive an item of identification information with the query message from the at least one authenticator, and
wherein the checking unit is configured to check the authorization of the at least one authenticator to receive the response message to the transmitted query message based on the received item of identification information.

5. The apparatus of claim 1, further comprising a storage device configured to store at least one item of authorization information for the authorization of the at least one authenticator, the checking unit being configured to check the authorization of the at least one authenticator based on the received query message and the at least one stored item of authorization information.

6. The apparatus of claim 1, wherein the receiving unit is configured to receive an item of authorization information with the query message from the at least one authenticator, and
wherein the checking unit is configured to check the authorization of the at least one authenticator to receive the response message to the transmitted query message based on the received item of authorization information.

7. The apparatus of claim 1, further comprising:
a storage device configured to store a number of items of authorization information for the authorization of a number of authenticators, a request message to be received being assigned to the respective item of authorization information, and
an updating unit configured to update the respective item of authorization information when the receiving unit receives the query message assigned to the respective item of authorization information.

8. The apparatus of claim 7, wherein the updating unit is configured to update the respective item of authorization information such that the associated authorization is revoked when the receiving unit receives the query message assigned to the respective item of authorization information.

9. The apparatus of claim 7, wherein the updating unit is configured to provide an item of security level information for the received query message based on the updated authorization information, the transmitting unit being configured to transmit the provided security level information with the predetermined response message to the at least one authenticator.

10. The apparatus of claim 1, wherein the checking unit is configured to check a format of the received query message before checking the authorization of the at least one authenticator.

11. A system comprising:
an apparatus for authenticating a product with respect to at least one authenticator, the apparatus comprising:
a receiving unit configured to receive a query message transmitted by the at least one authenticator;
a checking unit configured to check an authorization of the at least one authenticator to receive a response message to the received query message; and
a transmitting unit configured to transmit a predetermined response message to the at least one authenticator based on the checked authorization and the received query message; and
the at least one authenticator for transmitting the query message to the apparatus and for receiving and checking a response message that is received from the apparatus in response to the transmitted query message.

12. The system of claim 11, wherein the at least one authenticator and the apparatus are configured such that the at least one authenticator is authenticated with respect to the apparatus.

13. The system of claim 11, wherein the at least one authenticator comprises a first authenticator and a second authenticator, the first authenticator being configured to generate an authorization to receive a response message from the apparatus by transmitting a query message to the apparatus and by receiving a corresponding response message from the apparatus, and to forward the generated authorization with an integrity-protected forwarding message to the second authenticator.

14. A method for authenticating a product with respect to at least one authenticator, the method comprising:
receiving a query message transmitted by the at least one authenticator;
checking an authorization of the at least one authenticator to receive a response message to the transmitted query message; and
transmitting a predetermined response message to the at least one authenticator based on the checked authorization and the received query message.

15. A computer program product comprising a non-transitory computer-readable storage medium having instructions executable by a program-controlled device to authenticate a product with respect to at least one authenticator, the instructions comprising:
receiving a query message transmitted by the at least one authenticator;
checking an authorization of the at least one authenticator to receive a response message to the transmitted query message; and
transmitting a predetermined response message to the at least one authenticator based on the checked authorization and the received query message.

16. The system of claim 11, wherein the apparatus is integrated with the receiving unit, the checking unit and the transmitting unit in the product.

17. The system of claim 11, wherein the receiving unit and the transmitting unit are integrated in the product, and the checking unit is connected upstream of the product such that query messages addressed to the receiving unit of the product are transmittable only via the checking unit of the apparatus.

18. The system of claim 11, wherein the receiving unit is configured to receive an item of identification information with the query message from the at least one authenticator, and
wherein the checking unit is configured to check the authorization of the at least one authenticator to receive the response message to the transmitted query message based on the received item of identification information.
